(19) United States
(12) Patent Application Publication
(10) Pub. No.: US 2013/0260355 A1
(43) Pub. Date: Oct. 3, 2013

(54) TEACHING AND LEARNING SYSTEM

(71) Applicant: Gobstopper, Inc., Redwood City, CA (US)

(72) Inventors: Jason Singer, Redwood City, CA (US); David Geoffrey Glickman, San Francisco, CA (US)

(73) Assignee: Gobstopper, Inc., Redwood City, CA (US)

(21) Appl. No.: 13/854,197

(22) Filed: Apr. 1, 2013

Related U.S. Application Data
(60) Provisional application No. 61/619,083, filed on Apr. 2, 2012.

(51) Int. Cl. G09B 5/08

(52) U.S. Cl. CPC G09B 5/08
USPC 434/350

(57) ABSTRACT

A computer-implemented method includes generating a curriculum for a particular textual work, the curriculum including one or more of: video content; audio content; and a quiz; and associating the curriculum with the particular textual work. The curriculum may be obtained from a store and then associated with the work. A student obtains a particular textual work, the work having a curriculum associated therewith, and reads the particular textual work under control of the curriculum.

### RELATED APPLICATIONS

This application is related to and claims priority from U.S. Provisional Patent Application No. 61/619,083, titled “Teaching and Learning System,” filed Apr. 2, 2012, the entire contents of which are hereby fully incorporated by reference for all purposes.

### BACKGROUND OF THE INVENTION

### Copyright Statement

This patent document contains material subject to copyright protection. The copyright owner has no objection to the reproduction of this patent document or any related materials in the files of the United States Patent and Trademark Office, but otherwise reserves all copyrights whatsoever.

### Field of the Invention

This invention relates to teaching and learning systems. More particularly, this invention relates to teaching and learning systems using customizable curricula.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 provides an overview of a teaching and learning system;

FIG. 2 provides an overview of aspects of a computer system used in a teaching and learning system;

FIGS. 3(a)-3(b) show exemplary aspects of a teacher's experience using curriculum creator;

FIGS. 4(a)-4(d) show exemplary aspects of a student's experience using a reader;

FIG. 5 shows an exemplary interface to a student dashboard;

FIG. 6 shows an exemplary interface to a teacher dashboard;

FIG. 7 shows an exemplary interface to a store;

FIG. 8 is a schematic diagram of a computer system; and

FIGS. 9(a)-9(g) are screen shots showing aspects of the system.

### DETAILED DESCRIPTION OF THE PRESENTLY PREFERRED EXEMPLARY EMBODIMENTS

### Background and Overview

Classroom teaching is just one aspect of the overall education of a student, especially a K-12 school student. It is well understood that homework is an important part of every student's learning process. Homework may be used, e.g., to reinforce concepts already taught or to introduce new concepts to a student.

A good teacher is able to monitor students in the classroom to determine whether or not individual students have understood relevant facts and concepts. This monitoring may involve, e.g., requesting and/or providing feedback, or it may involve simply tracking the amount of time students spend on a certain task or project. However, there is generally no way for a teacher to actively support or monitor each student while that student is doing his or her homework. In fact, there is generally no way for a teacher to even know if a student has done their homework.

Given the critical value of homework to a student's overall learning experience, the inventors realized that it would be valuable to have a system that would allow teachers to support students while they are in the process of doing their homework by providing explanations in context and checking for understanding, as well as a system that would support a teacher tracking what a student has actually done and their level of mastery of the material completed for homework.

When students arrive at school in the morning, it would be useful for their teachers to know not just that they did their homework, but other information such as, e.g., how much time they spent and how much they understood (or didn't understand) of the assigned tasks. The school and/or teacher would also be able to measure the impact of explanations they have provided on student learning From a school's (or teacher's) perspective, this will allow a teacher to start a day's lessons with prior knowledge of what a class of students (and individual students in the class) already know and what is giving difficulty to the class (or the individual students).

Description

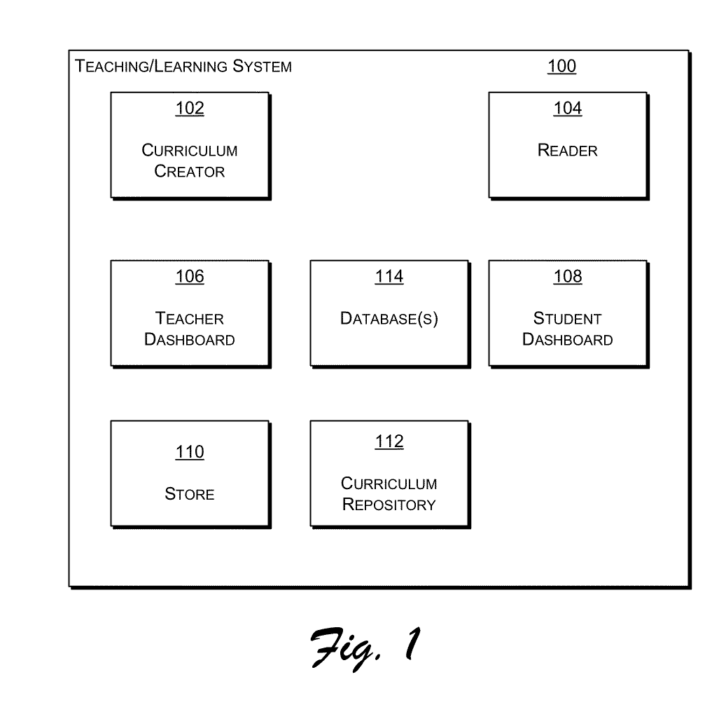

FIG. 1 provides an overview of an exemplary teaching and learning system 100. As shown in FIG. 1, a teaching and learning system 100 may include various components, including a curriculum creator 102, a reader 104, a teacher dashboard 106, a student dashboard 108, a store 110, a curriculum repository 112, and various databases 114. Those of skill in the art will realize and understand, upon reading this description, that some systems may not include all of the components. For example, some systems 100 may not include a store or a curriculum creator.

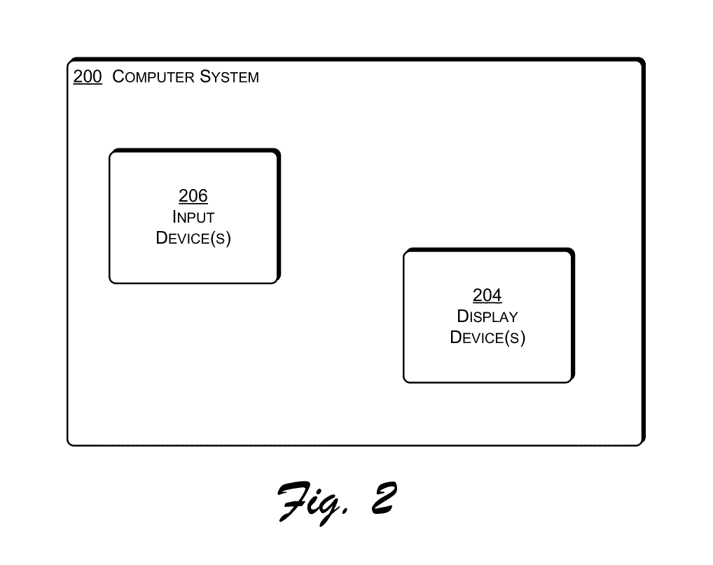

As will be explained in greater detail below, aspects of this invention may be implemented using computer systems. FIG. 2 provides an overview of aspects of a computer system used in a teaching and learning system 100. In particular, FIG. 2 shows a typical computer system 200 including one or more display devices 204 and one or more input devices 206. In the discussion that follows it should be appreciated and understood that an appropriate computer system will be used for the various aspects of the system. For example, the curriculum creator 102 may be implemented as software running on a computer such as a PC or a Mac, whereas the reader 104 may be implemented on a computer system such as an iPad or an e-reader of some sort, and the store 110 may be implemented using a server system that interfaces with payment systems and the like. In presently preferred implementations, access to the some or all parts of the system will be via web interfaces.

The Curriculum Creator

The curriculum creator 102 is used to create a curriculum (also referred to herein as a “curriculet”) that may be used in conjunction with existing content to provide guidance and assistance for students and feedback and tracking for teachers.

Within the curriculum creator 102, an educator or teacher may create a curriculum that essentially acts as a control layer on top of existing content. The content may be, e.g., a textbook, a poem, a fictional book, or the like. The layer may include optional or required questions, links to other media (e.g., movies, pictures, audio), questions, quizzes, tests, comments, and the like. Those of skill in the art will realize and understand, upon reading this description, that this list is not exhaustive, and other forms of content may be included.

Using the curriculum creator 102, an educator or teacher may insert instructions such as:
“before turning to the next page, ask the question . . . ”. The student may be required to get the correct answer before moving on.
On page 5, embed a video (e.g., of the teacher explaining something)

Those of skill in the art will realize and understand, upon reading this description, that these are just examples of the kind of controls and inputs that can be added to a document.

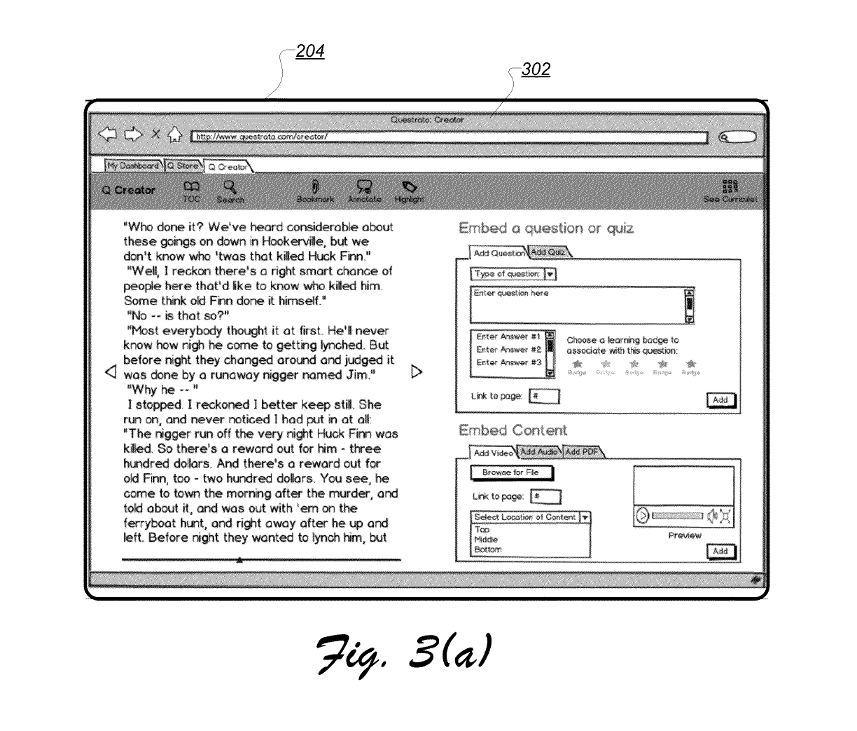

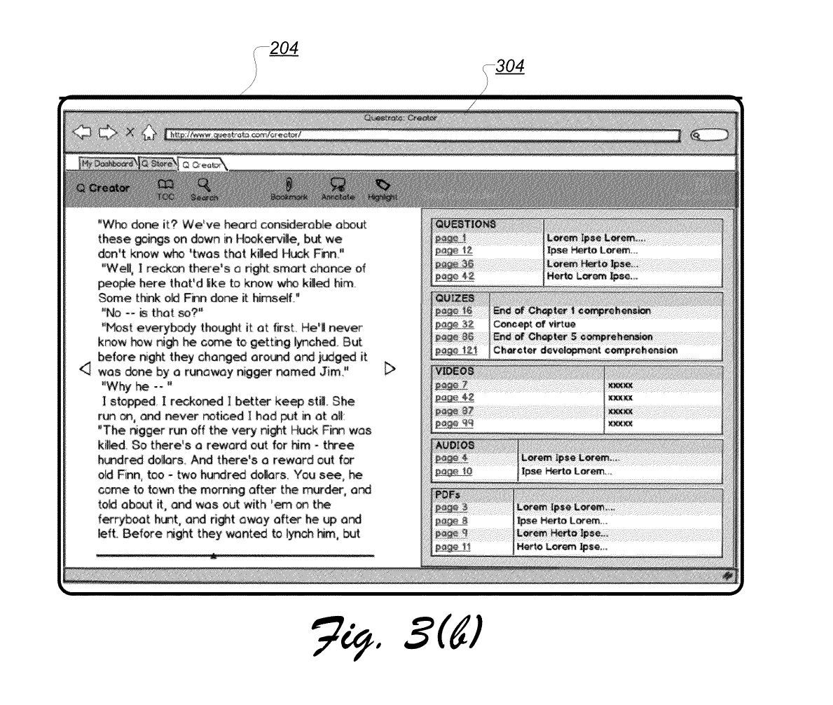

FIG. 3(a) shows an example screen interface 302 to a curriculum creator 102. The screen interface 302 is shown on display 204 of a computer device. The left side of the interface screen 302 shows the text of a novel (in this case Huckleberry Finn) for which the teacher is creating a curriculet. The right side of the screen shows various options that the teacher can insert into a layer over the text. As seen in the drawing, the teacher can add a question, add a quiz, and/or embed content (video, audio, PDF) in various locations in the page.

FIG. 3(b) shows another example screen interface 304 to the curriculum creator 102. In the interface 304 the creator shows a summary of the curriculet on the right side of the screen.

The Reader 104

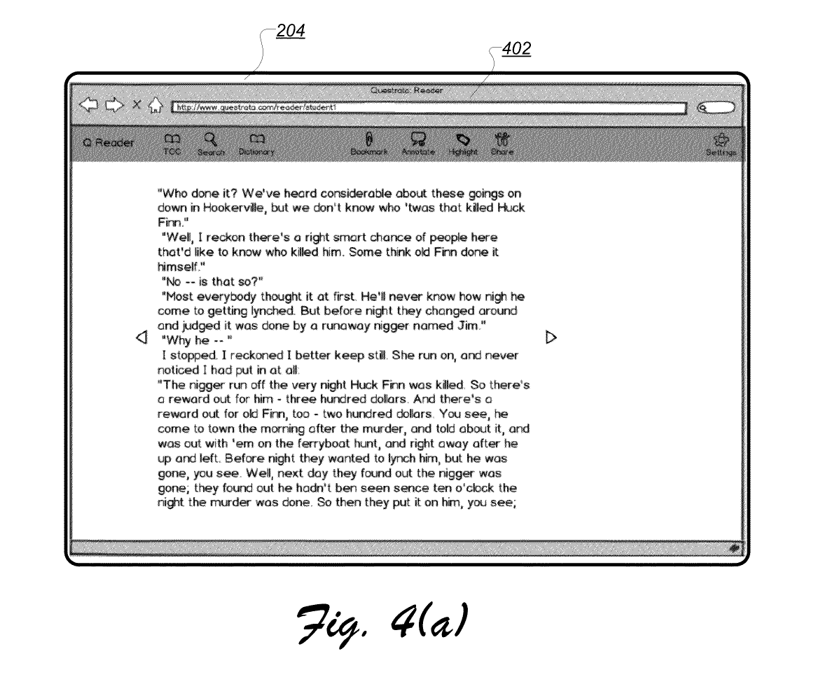

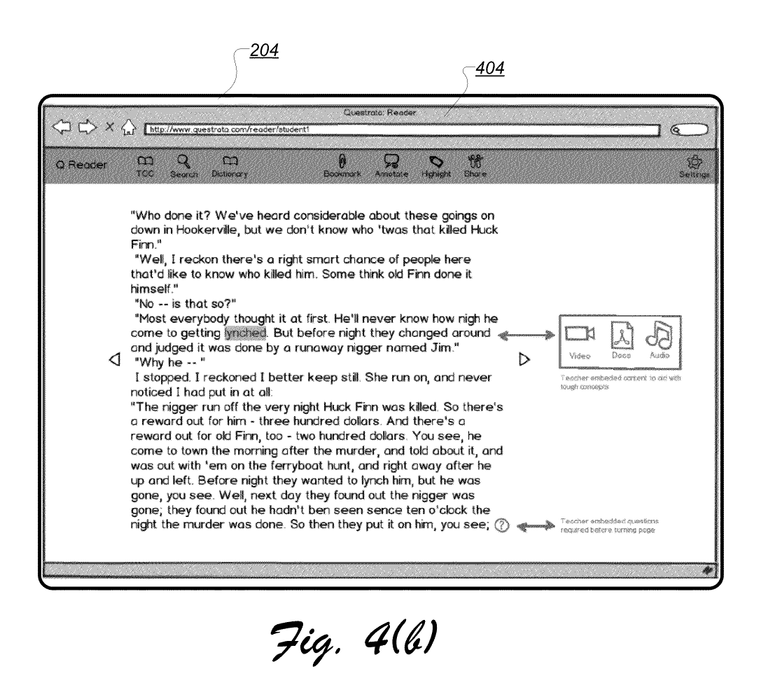

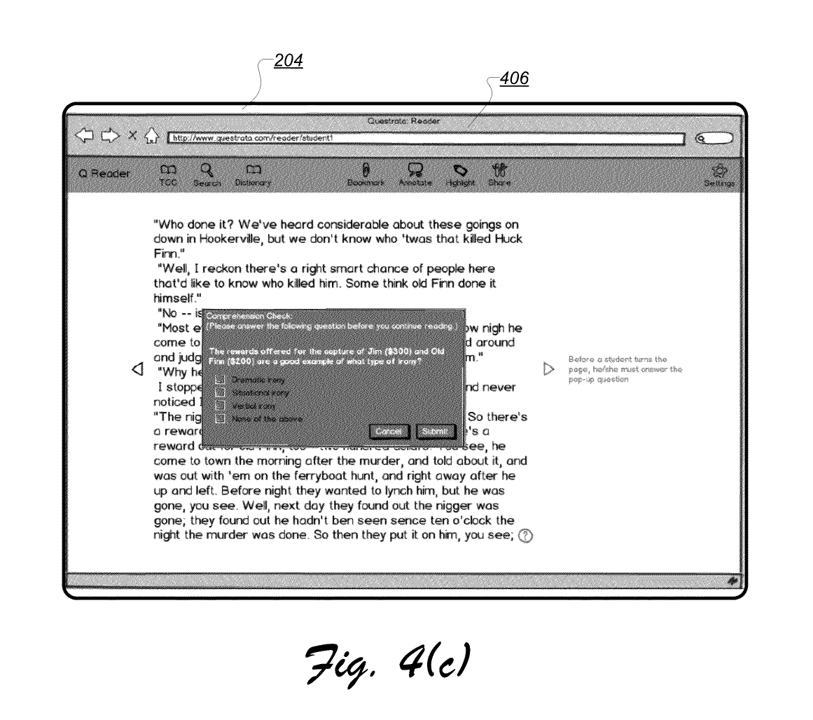

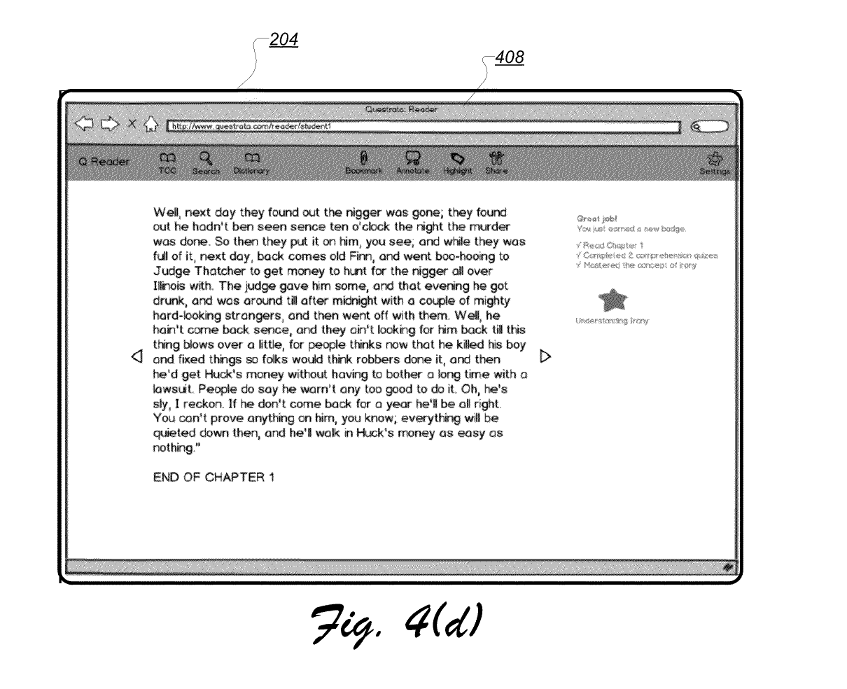

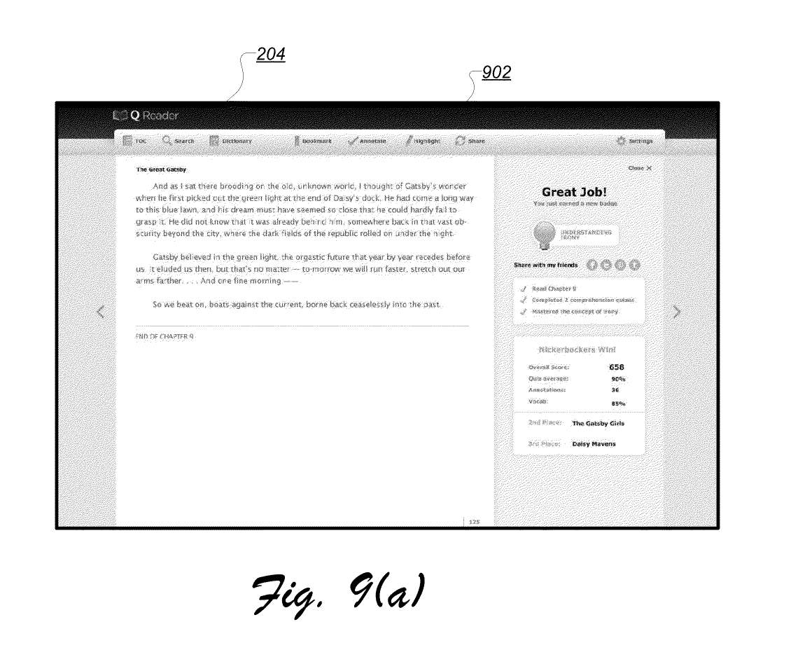

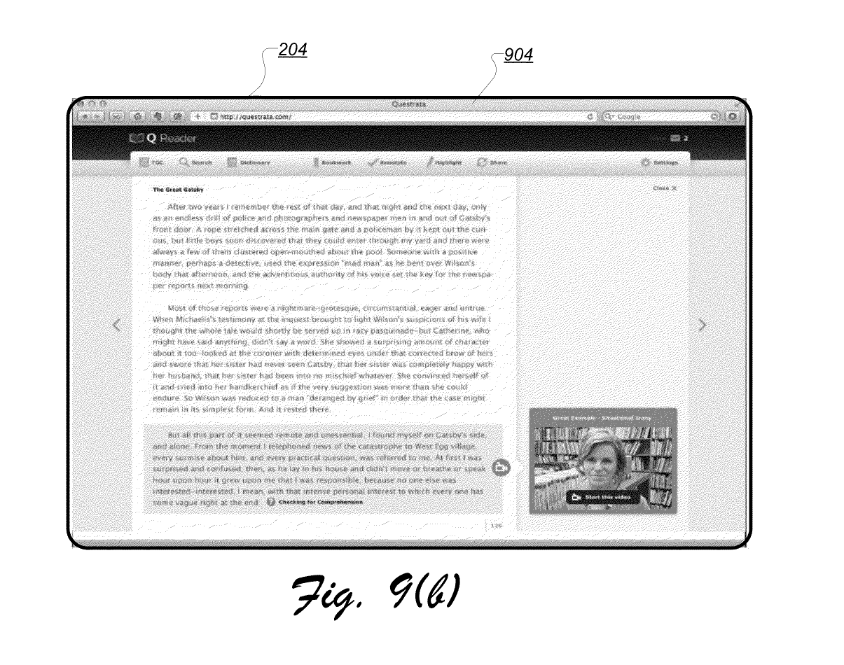

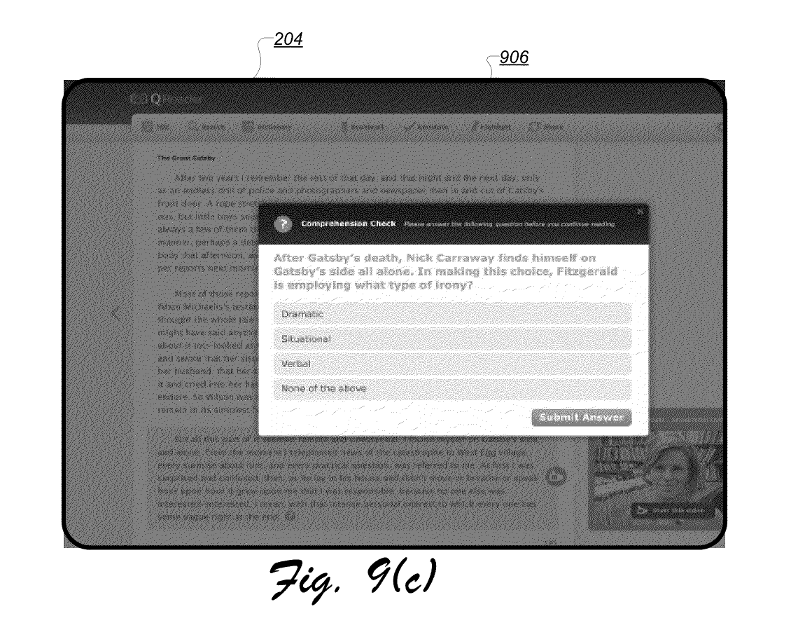

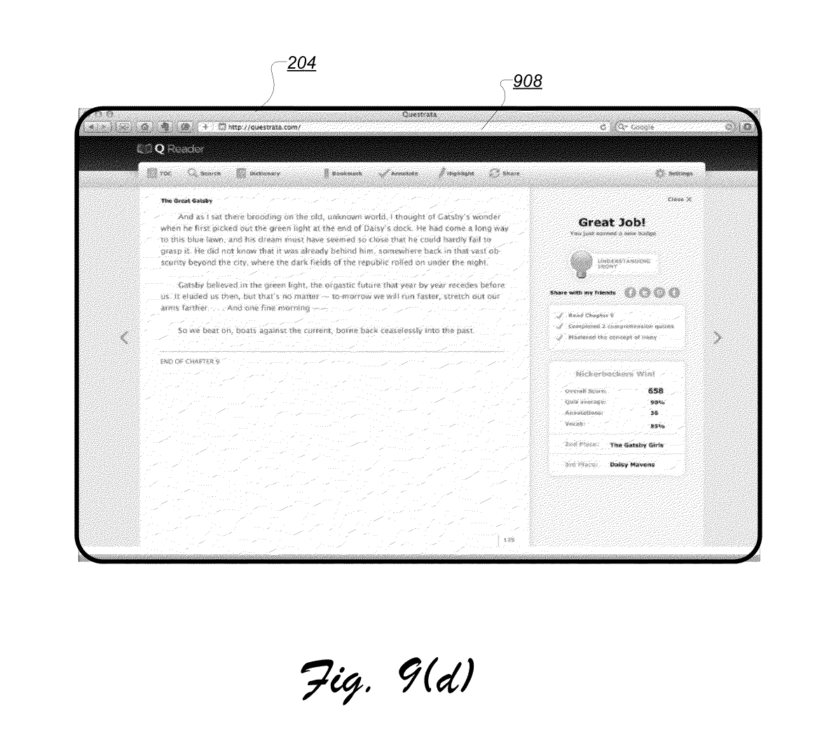

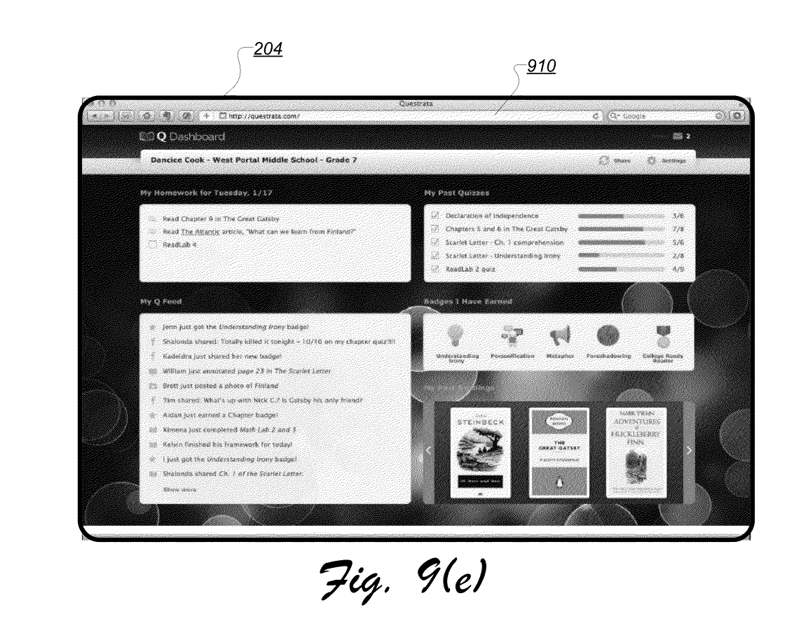

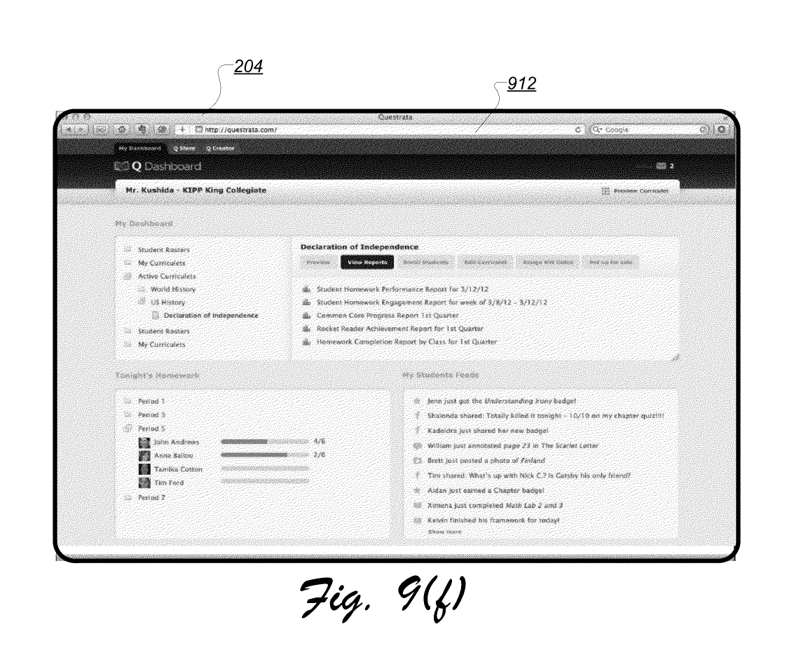

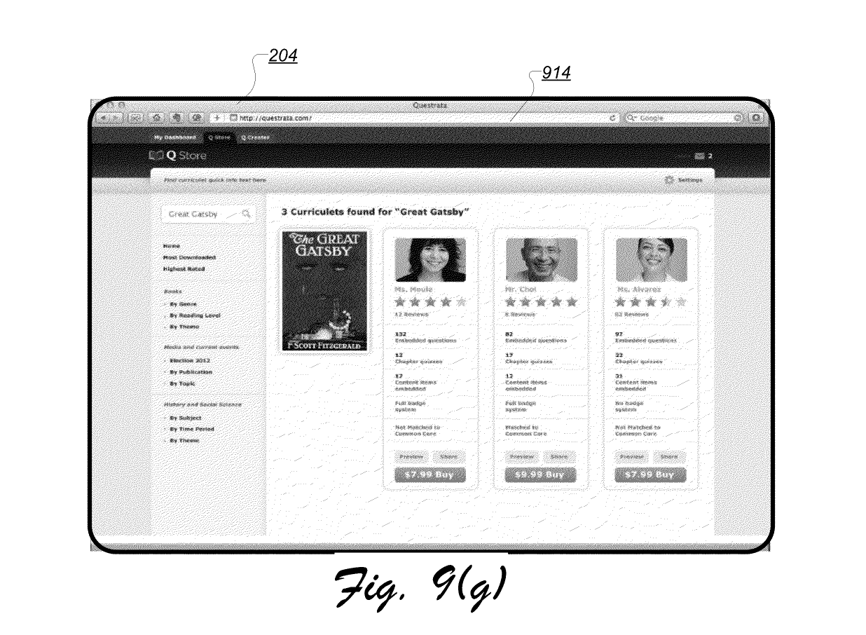

FIGS. 4(a)-4(d) show exemplary aspects of a student's experience using the reader 104. FIG. 4(a) shows a page 402 of the reader displayed on a display 204 of the student's computing device (e.g., a personal computer, an e-reader, a phone, etc.). FIG. 4(b) shows the same page as in FIG. 4(a), this time displayed with teacher embedded concepts to aid with certain concepts. In this example, the teacher has embedded video, documents and audio to help explain the work “lynched” in the text. In this example the teacher has also embedded questions that the student must answer in order to turn the page. (See also FIG. 9(b) with an example of an embedded video.) FIG. 4(c) shows the same page as FIG. 4(a) with a pop-up question that the student must answer before turning the page. (See also FIG. 9(c)) It should be noted that in this example the student is not prevented from turning the page if they answer the question incorrectly. Those of skill in the art will realize and understand, upon reading this description, that different types of questions may be asked and that student progress may be controlled using the questions (e.g., by preventing the student from moving forward in the text) or the student's progress may be monitored using the questions, without placing limits on a student's progress through the text.

FIG. 4(d) shows a page displayed using the reader 104. In the page shown in FIG. 4(d), the student has completed the chapter and is provided with feedback (on the right side of the page). In the example shown, the student feedback includes an award of a badge (in this case for “Understanding Irony”) as well as an announcement that the student's team has won an instructional game that leverages the invention using familiar instructional strategies such as group work. Those of skill in the art will realize and understand, upon reading this description, that this list is not exhaustive, and other forms and examples of gamification and recognition may be included. See also, e.g., FIG. 9(d) showing an element of gamification based on group work wherein the teacher groups students during an assignment and awards points based on certain criteria.

The teaching/learning system 100 may provide all kinds of feedback to students in order to help them track their progress as well as to try to motivate them. For example, as was shown in FIG. 4(d), students may be awarded stars or badges when they achieve certain milestones. The specific awards may be set by the teacher for this curriculet using the curriculum creator 102.

The Student Dashboard 108

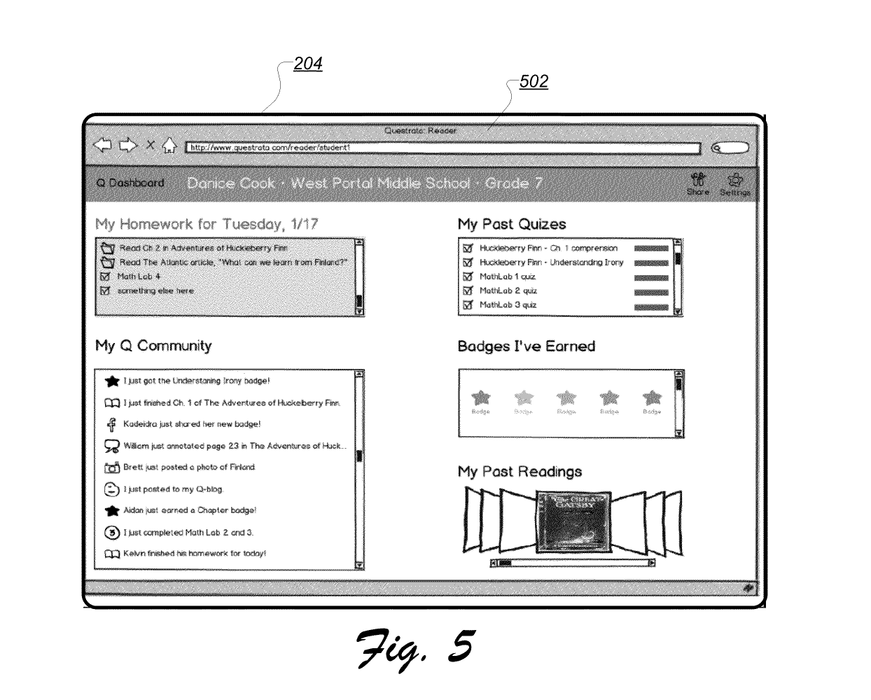

FIG. 5 shows an exemplary interface 502 to a student dashboard 108. (See also FIG. 9(e)) In preferred systems, each student is provided with access to a student dashboard which provides that student with access to the student's classes as well as other information. The student dashboard 108 may provide the student with, e.g., information regarding their homework, information about past quizzes and readings, information about badges the student has earned, and information about other students in that student's community.

The Teacher Dashboard 106

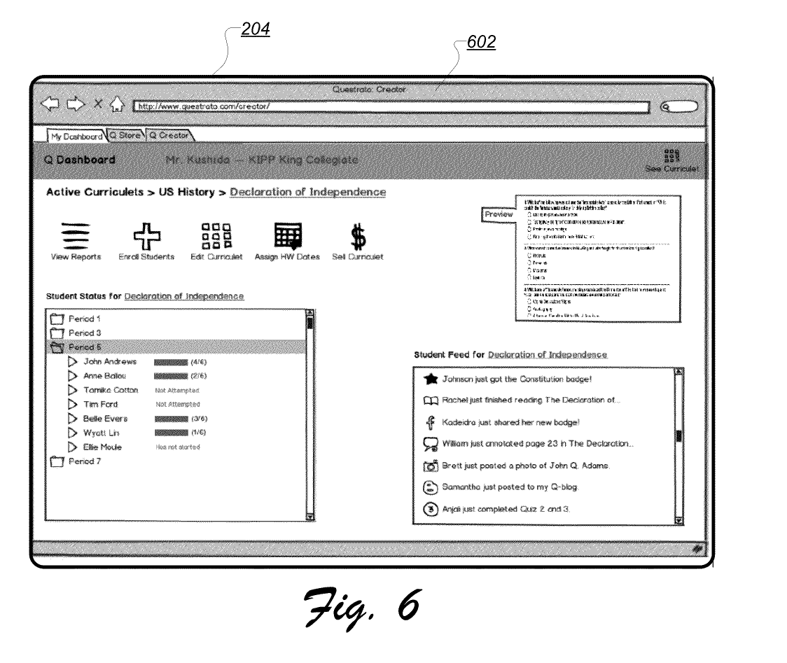

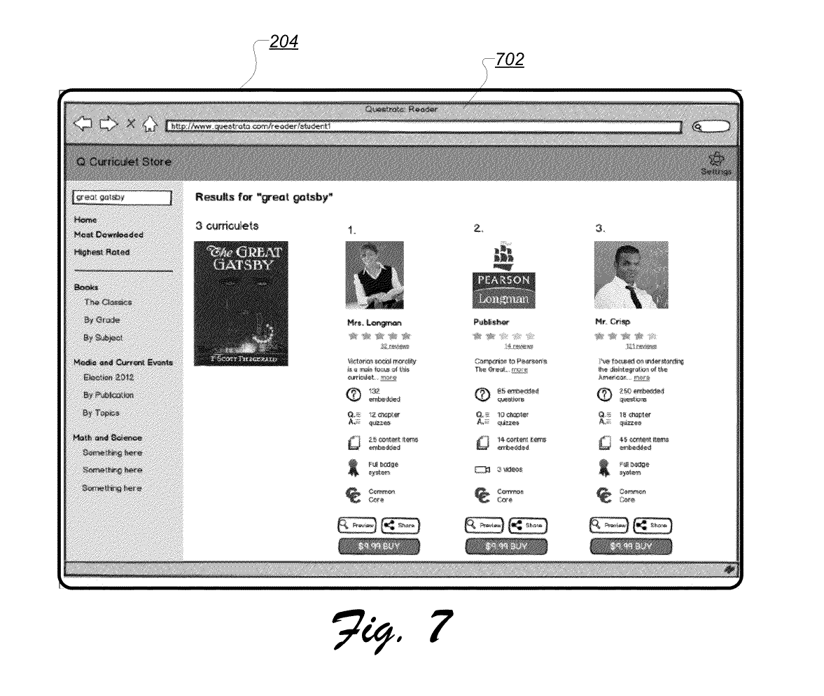

FIG. 6 shows an exemplary interface 602 to a teacher dashboard 106. (See also FIG. 9(f)) In preferred systems, each teacher is provided with access to a teacher dashboard which provides that teacher with access to the teacher's classes, students, curricula, and other information. In the example shown in FIG. 7, the teacher has four classes (denoted “Period 1”, “Period 3”, “Period 5”, and “Period 7”). In the example shown in the drawing, the teacher receives feedback on the current status of various students (in the region on the right side of the display).

It will be apparent to those of skill in the art, upon reading this description, that a teacher can obtain real-time or non-real-time feedback on various students. In this manner a teacher can track which students have done their homework, and, depending on the curriculet used, the degree to which students have understood the concepts being taught or reinforced by the homework.

The Store 110

Curriculets may be created, e.g., by teachers, using the curriculum creator 102. These curriculets may be provided to other teachers (e.g., by being offered for sale). In addition, book publishers, school systems or any other entities may offer their own curriculets. In preferred systems, users (e.g., teachers) may obtain curriculets through a store (e.g., an online store). FIG. 7 shows an exemplary interface 702 to a store 110. (See also FIG. 9(g)) In the example shown in FIG. 7, three (3) curriculets are available for “The Great Gatsby.” The store user is provided with information about each curriculet in order to enable that user to evaluate the curriculet before purchase.

Summary

Low homework completion makes teachers inefficient and ineffective. Class time is consumed with quizzing and teachers scramble to respond the next day when students fail to complete assigned homework from the night before. The system disclosed herein avoids these problems and provides some or all of the following advantages:

Differentiated homework—for every student. Readers of all level readers all served questions in their sweet spot. Video and audio embedded explanations may be provided at exactly the right place and time. Embedded rich media can make homework more engaging.

Daily lessons may be improved or perfected using real-time data from the night before. This way teachers will not have to use class time to teach students what they don't (but should) know. This allows for more class time for group work, project-based learning, Socratic discussions, and the like. Students may be grouped based on understanding and ability.

Using the system disclosed herein, teachers are able to know whether their students did their homework, whether students understood the material, how long the homework actually took each student, and how long each student was engaged. Students are provided with a dynamic learning portal that helps them manage and organize homework, tracks progress and performance, and allows them to interact with each other through a learning-focused social network.

Thus, in some aspects, the system provides an educational technology solution that can help teachers become effectively omniscient (providing data on student homework performance before class even starts) and omnipresent during the portion of the learning day over which they typically have no control—homework time.

In some aspects, the system allows teachers to build and place a layer of questions and embedded documents, video, and/or audio on top of any digital document be it a novel, textbook, magazine article or primary resource which students can read in an e-reader (e.g., a HTML5-based e-reader).

The reader will preferably be browser based and run in the cloud so it can be accessed from any device (e.g., desktop, laptop, smartphone, tablet) without a download and allow students to read and interact with documents in multiple formats (epub, pdf, etc.) whenever and wherever they choose to access it.

This system may provide a new level of accountability and support for students during homework time. E.g., a student may not be able to move on to a new page in the text until they answer the question their teacher has embedded on that page or until they take the end of chapter quiz the teacher has embedded at the end of the reading assignment. If a teacher wants to talk about how something (e.g., irony) works in a paragraph on a page, she will be able to embed a video, e.g., a teacher-made video, on that page.

A teacher design console gives teachers the power to determine the student homework experience by empowering teachers to design and build curriculets. When teachers are finished building a curriculet for a novel, they can use it for their own class and offer it up for sale in a marketplace. If they like a curriculet they see in the marketplace, they can purchase it and assign it to their students and it will show up on their students' homepage and begin feeding the teacher data as soon as it is assigned.

In use, a student logs into the system, and selects (e.g., clicks on) a homework link assigned by the teacher. The student's reader opens up to the assigned page and the student is able to begin their homework. Student performance on previous quizzes may be displayed on their homepages, their class is their social network, and they can earn and show off the badges they have earned along the way (teachers embed a badge system in their curriculets).

Computing

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

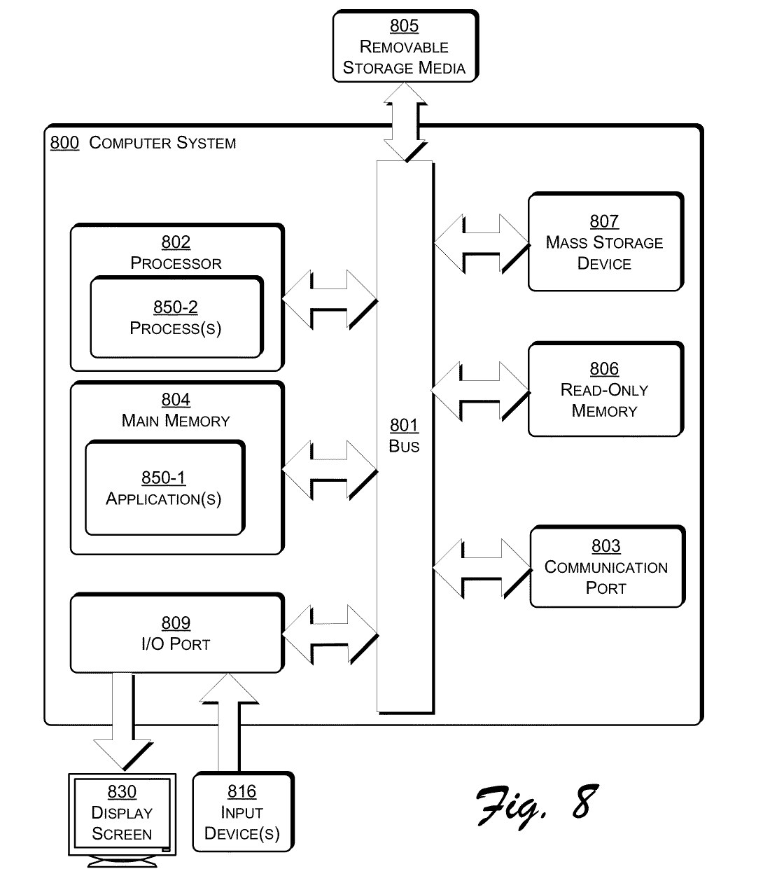

FIG. 8 is a schematic diagram of a computer system 800 upon which embodiments of the present disclosure may be implemented and carried out.

According to the present example, the computer system 800 includes a bus 801 (i.e., interconnect), at least one processor 802, at least one communications port 803, a main memory 804, a removable storage media 805, a read-only memory 806, and a mass storage 807.

Processor(s) 802 can be any known processor, such as, but not limited to, an Intel® Itanium® or Itanium 2® processor(s), AMD® Opteron® or Athlon MP® processor(s), or Motorola® lines of processors, and the like. Communications port(s) 903 can be any of an RS-232 port for use with a modem based dial-up connection, a 10/100 Ethernet port, a Gigabit port using copper or fiber, or a USB port, and the like. Communications port(s) 803 may be chosen depending on a network such as a Local Area Network (LAN), a Wide Area Network (WAN), a CDN, or any network to which the computer system 800 connects. The computer system 800 may be in communication with peripheral devices (e.g., display screen 830, input device(s) 816) via Input/Output (I/O) port 809.

Main memory 804 can be Random Access Memory (RAM), or any other dynamic storage device(s) commonly known in the art. Read-only memory 806 can be any static storage device(s) such as Programmable Read-Only Memory (PROM) chips for storing static information such as instructions for processor 802. Mass storage 807 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 801 communicatively couples processor(s) 802 with the other memory, storage and communications blocks. Bus 801 can be a PCI/PCI-X, SCSI, a Universal Serial Bus (USB) based system bus (or other) depending on the storage devices used, and the like. Removable storage media 805 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), etc.

Embodiments herein may be provided as a computer program product, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 804 is encoded with application 850-1 that supports the functionality as discussed herein. Application 850-1 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 802 accesses main memory 804 via the use of bus 801 in order to launch, run, execute, interpret or otherwise perform the logic instructions of the application 850-1. Execution of application 850-1 produces processing functionality in process 850-2. In other words, the process 950-2 represents one or more portions of the application 850-1 performing within or upon the processor(s) 802 in the computer system 800.

It should be noted that, in addition to the process 850-2 that carries out operations as discussed herein, other embodiments herein include the application 850-1 itself (i.e., the un-executed or non-performing logic instructions and/or data). The application 850-1 may be stored on a computer readable medium (e.g., a repository) such as a disk, hard disk or in an optical medium. According to other embodiments, the application 850-1 can also be stored in a memory type system such as in firmware, read only memory (ROM), or, as in this example, as executable code within the main memory 804 (e.g., within Random Access Memory or RAM). For example, application 850-1 may also be stored in removable storage media 805, read-only memory 806, and/or mass storage device 807.

Example functionality supported by computer system 800 and, more particularly, functionality associated with application 850-1 is discussed above with reference to the drawings.

Those skilled in the art will understand that the computer system 800 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of skill in the art will appreciate that the process may operate without any user intervention. In another embodiment, the process includes some human intervention (e.g., a step is performed by or with the assistance of a human).

It should be appreciated that the words “first” and “second” in the claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A computer-implemented method, implemented by hardware in combination with software, the method comprising:
obtaining a particular textual work, said work having multiple curricula associated therewith, each curriculum of said multiple curricula having been created separately from said particular textual work;
selecting a particular curriculum from said multiple curricula, said particular curriculum including one or more of: video content, audio content, and a quiz;
providing a reader to multiple users, wherein the reader is a software application; and
enabling reading of said particular textual work by each of said multiple users, using said reader and under control of said particular curriculum,
wherein the reader controls reading of the particular textual work by each user separately based on the particular curriculum selected and based on each said users progress in reading said particular textual work using said reader, and wherein the particular curriculum causes the reader to track information about progress of each of said users reading said particular textual work, and wherein the particular curriculum causes the reader to provide feedback to each of said users about each of said user's respective progress reading said particular textual work using said reader, and wherein the particular curriculum causes the reader to provide feedback to a teacher about each of said user's respective progress reading said particular textual work using said reader.

2. The method of claim 1 wherein the feedback provided to the teacher for each particular user includes information about how much time the particular user spent reading the particular textual work using the reader.

3. The method of claim 1 wherein the reader is a web-based application.

4. The method of claim 1 wherein said particular curriculum is obtained via an interface to an online store.

5. A computer-implemented method, implemented by hardware in combination with software, the method comprising:
obtaining a particular textual work, said work having multiple curricula associated therewith, each curriculum of said multiple curricula having been created separately from said particular textual work;
selecting a particular curriculum from said multiple curricula, said particular curriculum including one or more of: video content, audio content, and a quiz;
providing a reader to multiple users; and
enabling reading of said particular textual work by each of said multiple users, using said reader and under control of said particular curriculum.

6. The method of claim 5 wherein the reader is a software application.

7. The method of claim 6 wherein the reader is a web-based application.

8. The method of claim 5 wherein the reader controls reading of the particular textual work based on the particular curriculum selected.

9. The method of claim 5 wherein said particular curriculum is obtained via an interface to an online store.

10. The method of claim 8 wherein the particular curriculum causes the reader to track information about progress of each of said users reading said particular textual work.

11. The method of claim 10 wherein the particular curriculum causes the reader to provide feedback to each of said users about each of said user's respective progress reading said particular textual work using said reader.

12. The method of claim 11 wherein feedback is provided to each user via a student dashboard interface.

13. The method of claim 11 wherein the particular curriculum causes the reader to provide feedback to a teacher about each of said user's respective progress reading said particular textual work using said reader.

14. The method of claim 11 wherein feedback is provided to the teacher via a teacher dashboard interface.

15. The method of claim 13 wherein the feedback provided to the teacher for each particular user includes information about how much time the particular user spent reading the particular textual work using the reader.

16. The method of claim 8 wherein the reader controls the reading of the textual work by each user separately, and based on each said users progress.

17. A system comprising:
a reader application constructed and adapted to enable reading of a particular textual work by a user under control of a particular curriculum, said particular textual work having multiple curricula associated therewith, each curriculum of said multiple curricula having been created separately from said particular textual work,
wherein the reader controls reading of the particular textual work by the user based on the particular curriculum and based on each said users progress in reading said particular textual work using said reader, and wherein the particular curriculum causes the reader to track information about progress of each of said users reading said particular textual work, and wherein the particular curriculum causes the reader to provide feedback to each of said users about each of said user's respective progress reading said particular textual work using said reader, and wherein the particular curriculum causes the reader to provide feedback to a teacher about each of said user's respective progress reading said particular textual work using said reader.

18. The method of claim 17 wherein said particular curriculum is obtained via an interface to an online store.
